(19) United States
(12) Patent Application Publication
(10) Pub. No.: US 2026/0074961 A1
(43) Pub. Date: Mar. 12, 2026

(54) TECHNOLOGIES FOR USER EQUIPMENT-TRAINED ARTIFICIAL INTELLIGENCE MODELS

(71) Applicant: Apple Inc., Cupertino, CA (US)

(72) Inventors: Ping-Heng Kuo, London (GB); Peng Cheng, Beijing (CN); Alexander Sirotkin, Tel Aviv (IL); Ralf Rossbach, Munich (DE); Yuqin Chen, Beijing (CN)

(73) Assignee: Apple Inc., Cupertino, CA (US)

(21) Appl. No.: 19/106,609

(22) PCT Filed: Aug. 26, 2022
(86) PCT No.: PCT/CN2022/115144

§ 371 Date: Feb. 25, 2025

(51) Int. Cl. H04L 41/16; H04W 24/10

(52) U.S. Cl. CPC H04L 41/16; H04W 24/10

(57) ABSTRACT

The present application relates to devices and components including apparatus, systems, and methods for user equipment-based artificial intelligence model training or reporting.

### BACKGROUND

Third Generation Partnership Project (3GPP) Technical Specifications (TSs) define standards for wireless networks. These TSs describe aspects related to communications between nodes of a radio access network within these wireless networks.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates another signaling diagram in accordance with some embodiments.

FIG. 4 illustrates another signaling diagram in accordance with some embodiments.

FIG. 5 illustrates another signaling diagram in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

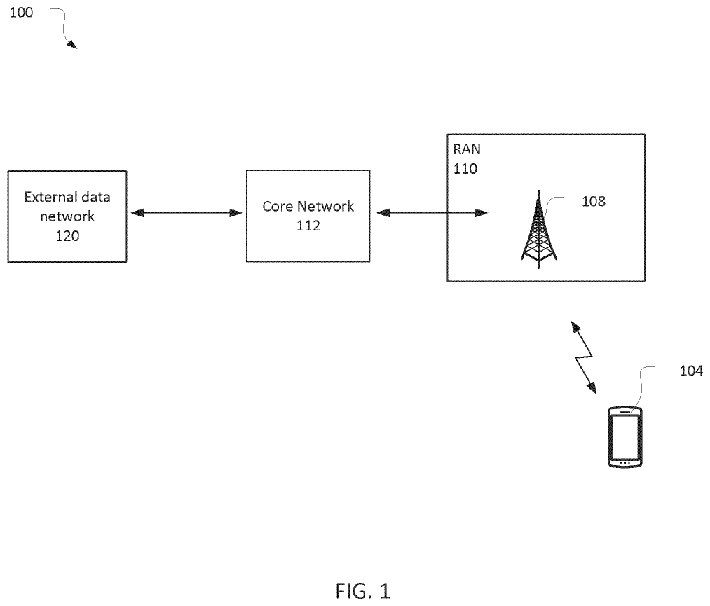

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system (for example, a Sixth Generation (6G) radio system). The base station 108 may provide user plane and control plane protocol terminations toward the UE 104.

The network environment 100 may further include a core network 112. For example, the core network 112 may comprise a 5^{th} generation core network (5GC) or later generation core network (for example, a 6^{th} generation core network (6GC)). The core network 112 may be coupled to the base station 108 via a fiber optic or wireless backhaul. The core network 112 may provide functions for the UEs 104 via the base station 108. These functions may include managing subscriber profile information, subscriber location, authentication of services, switching functions for voice and data sessions, and routing and forwarding of user plane packets between the RAN 110 and an external data network 120.

In some embodiments, one or more nodes of the network environment 100 may be used as an agent to train an AI model. An AI model, as used herein, may include a machine learning (ML) model, a neural network (NN), or a deep learning network.

In some embodiments, the AI model may be play a role in optimizing network functions. For example, an AI model may be trained by an AI agent in the wireless environment 100 and may be used to facilitate decisions made in the RAN 110 or the CN 112. These decisions may be related to beam management, positioning, resource allocation, network management (for example, operations, administration and maintenance (OAM) aspects), route selection, energy-saving, load-balancing, etc.

In some embodiments, the AI model may play a role in an AI-as-a-Service (AIaaS) platform. In an AIaaS platform, the AI services may be consumed by applications initiated at either a user level or a network level, and the service provider may be any AI agent reachable in the network environment 100.

As discussed herein, UEs in the network environment 100 (such as UE 104) may act as AI agents to train at least part of an AI model. The UE 104 may train an AI model based on a dataset available to the UE 104. The dataset may include data collected locally by the UE 104 or obtained by another node and provided to the UE 104. In some embodiments, the data may include radio-related measurements, application-related measurements, sensor input, etc.

In some embodiments, the UE 104 may train an AI model by determining a plurality of weights that are to be used within layers of a neural network. For example, consider a neural network having an input layer with dimensions that match the dimensions of an input matrix constructed of the dataset. The neural network may include one or more hidden layers and an output layer having M×1 dimensions that outputs an M×1 codeword. Each of the layers of the neural network may have a different number of nodes, with each node connected with nodes of adjacent layers or nodes of non-adjacent layers. In general, at some layer(s), a node may generate an output as a non-linear function of a sum of its inputs, and provide the output to nodes of an adjacent layer through corresponding connections. A set of weights, which may also be referred to as the AI model in this example, may adjust the strength of connections between nodes of adjacent layers. The weights may be set based on a training process with training input (generated from the dataset) and desired outputs. The training input may be provided to the AI model and a difference between an output and the desired output may be used to adjust the weights. In other embodiments, the UE 104 may train an AI model in other manners. For example, the UE 104 may use a dataset to determine parameter values of an AI model such as a decision tree or simple linear function in other manners.

Upon training an AI model, the UE 104 may report/transfer the trained AI model to a requesting service through the RAN 110 or the CN 112. The requesting service may be a function instantiated in the CN 112 or an application server of the external data network 120. In some embodiments, the AI model transmitted to the requesting service may be used for federated learning (FL). In these embodiments, the requesting service may be a model aggregator hosted in the network that fuses the AI model provided by the UE 104 with AI models provided by other UEs.

The UE 104 may report the AI model to the network using radio resource control (RRC) or non-access stratum (NAS) signaling.

Embodiments of the present disclosure provide detailed procedures for training and reporting AI models. These procedures may allow dynamic refinement of the AI models in an efficient manner that may be used to cope with fluctuating environmental attributes. In this manner, the AI models may be kept relevant and not become obsolete or otherwise degrade the system performance.

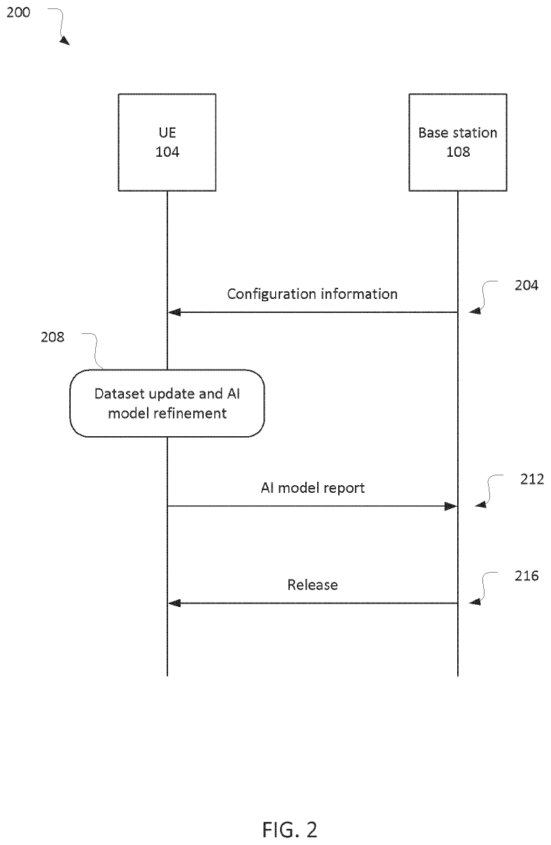

FIGS. 2-5 provide signaling diagrams of various AI model training/reporting operations in accordance with some embodiments. The signaling diagrams may include signals transmitted between the UE 104 and the base station 108. The signals transmitted between the UE 104 and the base station 108 may include RRC messages or messages at other protocol layers.

FIG. 2 is a signaling diagram 200 that illustrates aspects of AI model reporting in accordance with some embodiments.

The signaling diagram 200 may include, at 204, the base station 108 sending configuration information to the UE 104. The configuration information may configure the UE 104 to train and report one or more AI models. Each configuration may be associated with a model training/reporting configuration identifier (ID). Each configuration may include, either directly or by reference, one or more of the following configuration parameters.

A first configuration parameter may be an AI model use case parameter. This parameter may indicate a client of the AI model service that corresponds to this configuration. The client may be a network node (for example, RAN 110, CN 112, or an OAM node) or it may be an application that resides on, for example, an application server in the external data network 120. In some embodiments, the AI model use case parameter may provide a finer granularity. For example, the parameter may indicate a particular network function associated with the AI model (for example, beam management, positioning, resource allocation, network management, route selection, energy-saving, or load-balancing).

If the client is an application, an access stratum of the UE 104 may forward an instruction to an application layer of the UE 104. For example, the access stratum of the UE 104 may generate an AI model and provide the AI model to an application layer of the UE 104. The application layer of the UE 104 may then provide the AI model to an application layer of a requesting entity. In some embodiments, the application layer of the UE 104 may generate the AI model based on, for example, a dataset received from the access stratum of the UE 104.

A second configuration parameter may be a container to be used to report an AI model trained by an application layer. Additionally/alternatively, the container may be used to report an AI model to be used by a certain client or in a certain use case. For example, the AI model may be reported in a container if the AI model is to be used by an application of the external data network 120.

A third configuration parameter may include a dataset identification. The dataset identification may provide information related to identification/type of the data to be used to train AI models.

A fourth configuration parameter may be a dataset update periodicity. The dataset update periodicity may define how often the UE 104 is to update a dataset that is to be used to train an AI model corresponding to the associated configuration. The UE 104 may periodically update the dataset based on the dataset update periodicity. Updating the dataset may include, for example, performing new measurements of certain metrics or gathering new sensor readings.

A fifth configuration parameter may be a model refinement periodicity. The model refinement periodicity may define how often the UE 104 is to refine an AI model corresponding to the associated configuration. Refining an AI model may include generating a new/updated AI model based on an updated dataset.

A sixth configuration parameter may be a model reporting periodicity. The model reporting periodicity may define how often the UE 104 is to report a latest AI model corresponding to the associated configuration.

In some embodiments, the periodicities provided by the fourth, fifth, and sixth configuration parameters may be related with one another or even commonly defined. For example, in some embodiments, only one of the model refinement periodicity or the model reporting periodicity may be configured. If only the model refinement periodicity is configured, the UE 104 may autonomously report the model once it has been refined. If only the model reporting periodicity is configured, the UE 104 may autonomously update/refine the AI model whenever it needs to report the model in accordance with the configured reporting periodicity. The dataset update periodicity may be independently configured or may be tied to the model refinement. For example, the dataset update may occur before each instance of the model refinement. Conversely, the dataset update periodicity may be defined and the UE 104 may autonomously refine the model after each occurrence of the dataset update. In some embodiments, if the dataset update periodicity is not configured, the UE 104 may update the dataset based on a specific implementation.

While some embodiments may include the model reporting occurring immediately after the model refinement, in other embodiments, the base station 108 may configure the occurrence of these actions separately. For example, this may be useful in situations in which the network instructs the UE 104 to refine the model more frequently than reporting the model in order to save radio resources.

A seventh configuration parameter may include a model refinement instructions/policy. The model refinement instructions/policy may provide a set of rules on how the UE 104 is to refine the AI model. For example, the model refinement instructions/policy may provide an indication that the UE 104 needs to cooperate with a network node or another UE when refining the AI model. Additionally/alternatively, the model refinement instructions/policy may provide a specific algorithm or set of parameters that the UE 104 is to use to refine the AI model.

In some embodiments, the configuration may additionally/alternatively include training quality metrics such as, for example, a minimum amount of data within a dataset that is to be used for training, or a maximum age of data within the dataset used for training.

In some embodiments, one configuration may configure parameters for both training an AI model and reporting the AI model. In other embodiments, the model training and model reporting may be configured separately. In these embodiments, a model session may be associated with one training configuration ID and one reporting configuration ID. The training configuration ID may provide a training configuration with information such as AI model use case and model refinement periodicity. The reporting configuration ID may provide a reporting configuration with information such as model reporting periodicity.

After receiving the configuration information 204, the UE 104 may perform a dataset update and AI model refinement at 208. The dataset update task may be used to add/replace entries in an existing dataset used for AI model training. The AI model refinement task may be used to retrain the AI model with the latest dataset in order to obtain a new AI model that is more up-to-date. In some embodiments, an AI model may be re-trained on an existing dataset in the event other parameters (for example, reference values) have changed. The dataset update and AI model refinement performed at 208 may be based on the configuration parameters discussed above.

At 212, the UE 104 may report the AI model to the base station 108. The model reporting may be used to transfer the most recently trained AI model to the network.

The AI model may be reported to the base station 108 in an RRC message. In some embodiments, the UE 104 may only report AI models with respect to one configuration in an RRC message. In other embodiments, the UE 104 may jointly report AI models corresponding to different configurations in one RRC message.

As discussed above, in some embodiments, the AI model may be trained by an application layer of the UE 104. In these cases, the access stratum of the UE 104 may receive the trained AI model from the application layer and report it in a configured container that is transparent to the RAN 110. In these embodiments, the base station 108 may simply forward the container with the AI model to the external data network 120 through the core network 112.

In some embodiments, the signaling diagram 200 may include the base station 108 sending a release message to the UE 104 at 216. The release message may include an RRC message with a list of IDs of model training/reporting configurations that are to be released. Upon receiving the release message, the UE 104 may perform one or more of the following operations.

An access stratum of the UE 104 may notify an application layer of the UE 104 that the model training/reporting configurations corresponding to the IDs in the release message are to be released. This signaling between the access stratum and application layer may be desired in embodiments in which the AI model corresponding to the released model training/reporting configuration is trained in the application layer.

The UE 104 may discard any trained models corresponding to the model training/reporting configurations that are to be released. This may be done at the application layer or the access stratum layer of the UE 104.

After releasing the model training/reporting configuration, the UE 104 may consider itself not to be configured to perform related dataset update, model refinement, or model reporting.

In some embodiments, the UE 104 may transmit a request to the base station 108 to release one or more model training/reporting configurations. The request may include an RRC message with IDs corresponding to the one or more model training/reporting configurations. The release request may be included in a UE assistance information (UAI) message. In the event the base station 108 grants the request, the base station 108 may then signal the release in the release message 216.

The UE 104 may transmit a request for release if, for example, platform resources (for example, battery, compute, storage, or memory resources) are running low. In some embodiments, the request may include a reason for the release.

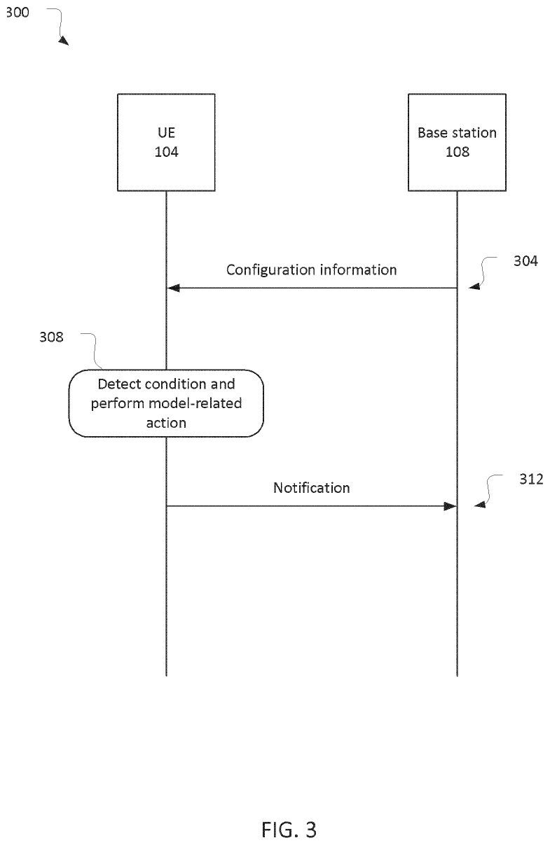

FIG. 3 is a signaling diagram 300 that illustrates aspects of AI model reporting in accordance with some embodiments.

The signaling diagram 300 may include, at 304, the base station 108 sending configuration information to the UE 104. The configuration information may configure the UE 104 to train and report one or more AI models similar to that described above with respect to FIG. 2.

The signaling diagram 300 may further include, at 308, the UE 104 detecting a condition and performing a model-related action. In some embodiments, the detected condition may be the expiration of a configured periodicity (for example, a dataset update periodicity, model refinement periodicity, or model reporting periodicity). In these embodiments, the model-related action may correspond to the associated task (for example, dataset update, model refinement, or model reporting).

In some embodiments, a model training/reporting configuration may configure the UE 104 to perform a model-related action when the UE 104 detects a predetermined trigger event. The model-related action may be associated with one of the tasks mentioned above (for example, a dataset update, model refinement, or model reporting). The model-related action may include performing, skipping, suspending, pausing, or stopping one or more of the noted tasks.

The trigger events may be related to one or more of the following.

A first trigger event may be associated with a difference between the AI model and a previous AI model being greater than a predetermined threshold. For example, if an updated AI model has been generated that includes more than a predetermined number of weighting factors that are different than those of a previous AI model, the UE 104 may proceed to report the updated AI model.

A second trigger event may be associated with a difference between the dataset and a previous dataset being greater than a predetermined threshold. For example, if an updated dataset includes more than a predetermined number of parameters that are different than those of a previous dataset, the UE 104 may proceed to perform a model refinement.

A third trigger event may be associated with a volume of the dataset being greater than a predetermined threshold. For example, if the UE 104 collects data over a predetermined threshold, the UE 104 may proceed to perform a model refinement.

A fourth trigger event may be associated with a location of the UE 104. For example, if the UE 104 determines it is at an edge of a coverage area, the UE may perform a dataset update.

A fifth trigger event may be associated with a mobility of the UE 104. For example, if the UE 104 is determined to be in a high-mobility state, the UE 104 may reduce a periodicity of the dataset update, model refinement, or model reporting.

A sixth trigger event may be associated with a battery level of the UE 104. For example, if the battery level is below a predetermined threshold, the UE 104 may skip one more instances of the dataset update, model refinement, or model reporting to save battery resources.

A seventh trigger event may be associated with a channel quality or status of a radio link. For example, if a channel quality is below a threshold, the UE 104 may skip a scheduled dataset update.

An eighth trigger event may be associated with compute, storage, or memory resources available at the UE 104. For example, if the available compute/storage/memory resources are below a predetermined threshold, the UE 104 may skip one more instances of the dataset update, model refinement, or model reporting to save platform resources.

A ninth trigger event may be associated with reception of an indication from an application layer, network, or other UE 104. For example, the UE 104 may receive a message from a requesting application layer that a particular application session has started or stopped and may start/stop the dataset update, model refinement, or model reporting as appropriate. For another example, the UE 104 may receive an indication in an access stratum or non-access stratum message from the network, or in a sidelink message from another UE and the UE 104 may perform a model-related action based on the indication.

A tenth trigger event may be associated with a change in an RRC state of the UE 104. For example, if the UE 104 transitions from an RRC connected state to an RRC idle state, the UE 104 may suspend the dataset update, model refinement, or model reporting.

An eleventh trigger event may be associated with a presence of a task having a first priority level that is higher than a second priority level of the model-related action. For example, if the UE 104 initiates a higher-priority task, the UE 104 may suspend the dataset update, model refinement, or model reporting until completion of the higher-priority task or sufficient resources become available.

The model-related actions given for the example trigger events above are illustrative and are not exclusive of actions that may be performed in other examples/embodiments.

At 312, the UE 104 may send a notification message to the base station 108. In some embodiments, the notification may include the results of the model-related action (for example, the notification may be a report of an updated AI model). In other embodiments, the notification may simply provide an indication of the action taken (for example, the UE 104 has performed, skipped, suspended, paused, or stopped the dataset update, model refinement, or model reporting).

In some embodiments, the UE 104 may provide the AI model as a differential report in which only the differences between the current AI model and a reference AI model are reported instead of the entire AI model. The reference AI model may be a previously reported AI model or the last AI model transmitted as a regular report.

Differential reporting, which may be used for periodic or event-triggered AI model reporting, may be used to reduce the signaling overhead.

In some embodiments, the UE 104 may indicate whether a report is a regular report or a differential report. The regular report may include a whole trained model that may be used as a reference for a subsequent differential report. The differential report may provide the differential information with respect to a reference AI model that has been previously reported. The differential information may include, for example, weighting factors that are different than those found in the reference AI model. The reference AI model may be a whole model from a regular report, or may be a model determined from a differential report.

Upon receiving a differential report, the base station 108 may derive the current AI model by aggregating the differential information with the reference AI model.

In some embodiments, the UE 104 may be configured to periodically reset differential reporting. For example, the UE 104 may be configured to transmit a regular report after a predetermined number of differential reports. In this manner, the reference AI model may be periodically refreshed.

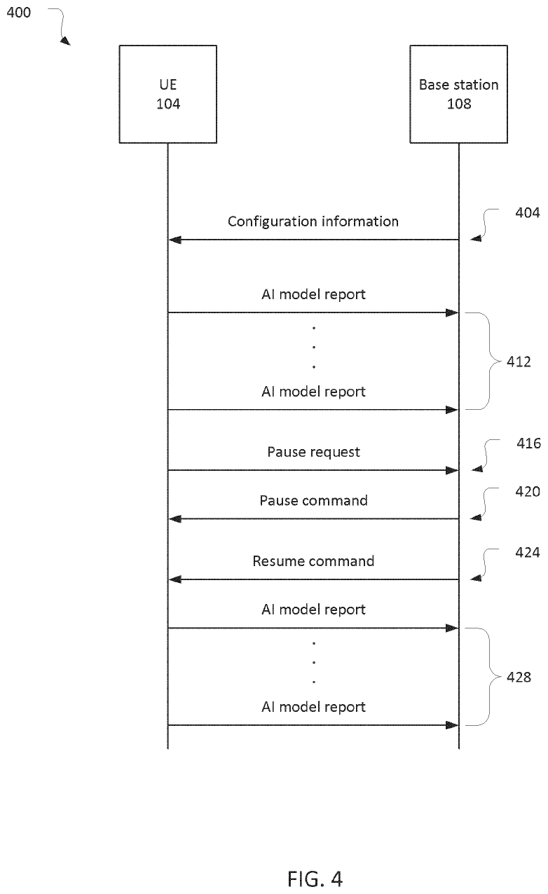

FIG. 4 is a signaling diagram 400 that illustrates aspects of AI model reporting in accordance with some embodiments.

The signaling diagram 400 may include, at 404, the base station 108 sending configuration information to the UE 104. The configuration information may configure the UE 104 to train and report one or more AI models similar to that described above with respect to FIG. 2.

Based on the configuration information, the UE 104 may generate and send one or more AI model reports 412. The reports may be periodic or event-triggered reports.

In some embodiments, the UE may detect a condition in which the AI model training/reporting becomes burdensome or otherwise undesirable. For example, the UE 104 may instantiate a higher-priority task or be running low on platform resources. Upon detecting such a condition, the UE 104 may proactively request that AI model training/reporting be suspended or paused by sending a pause request at 416.

The base station 108 may send a pause command at 420. In some embodiments, the base station may send the pause command at 420 based on the pause request received at 416. However, in other embodiments, the base station 108 may proactively send the pause command at 420 without receiving a specific request.

Upon receiving the pause command at 420, the UE 104 may perform one or more of the following operations.

In some embodiments, the UE 104 may stop performing a dataset update task upon receiving the pause command.

In some embodiments, the UE 104 may continue to perform the dataset update task, but may stop performing the model refinement task.

In some embodiments, the UE 104 may continue to perform the dataset update and model refinement tasks, but may store the refined AI models without reporting them to the base station. In these embodiments, the UE 104 may keep the stored AI models for a predetermined time interval (for example, the stored AI models may be discarded/replaced when an associated timer expires). Additionally/alternatively, the UE 104 may keep the stored AI models until the UE 104 is instructed to resume reporting.

The signaling diagram 400 may further include the base station 108 sending a resume command at 424. Upon receiving the resume command at 424, the UE 104 may resume AI model reports at 428.

In some embodiments, the UE 104 may report stored AI models (if any) in a first AI model report of the AI model reports at 428.

In some embodiments, after receiving the resume command at 424, the UE 104 may perform both a dataset update and a model refinement to obtain an AI model to report in the first AI model report of the AI model reports at 428. In other embodiments, the UE 104 may perform a model refinement without updating the dataset, with the obtained AI model reported in the first AI model report of the AI model reports at 428.

In various embodiments, the behavior of the UE 104 upon reception of the pause/resume commands may be predefined, specified in, for example, a 3GPP TS, or up to UE implementation.

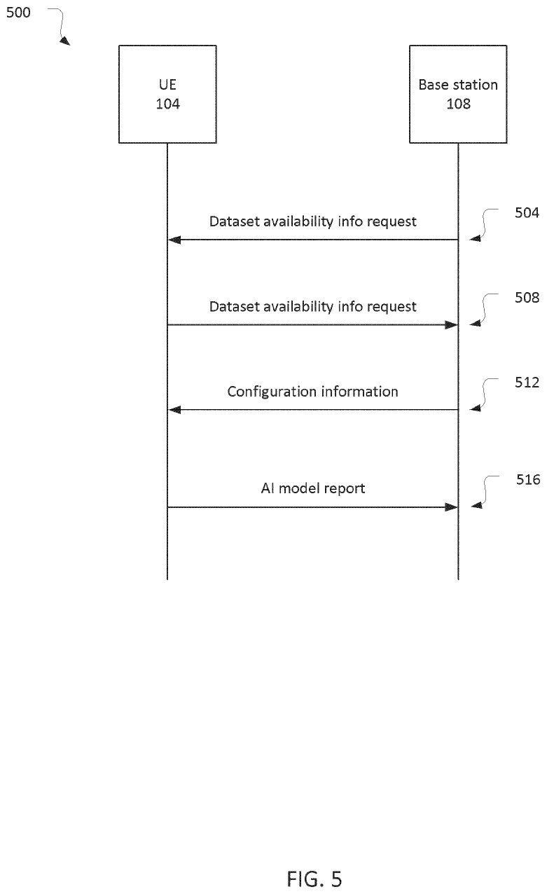

FIG. 5 is a signaling diagram 500 that illustrates aspects of AI model reporting in accordance with some embodiments.

The signaling diagram 500 may include, at 504, the base station 108 sending a dataset availability information request message to the UE 104. The dataset availability information request message may be used to ensure the UE 104 is able to continuously and persistently perform modeling tasks (for example, dataset update, model refinement, and model reporting). The dataset availability information request may request the UE 104 to provide information about its capability to collect and update a particular dataset continuously. The dataset availability information request message may provide a list of parameters that may be used to train a targeted AI model.

The UE 104 may, upon receiving the dataset availability information request, respond with a dataset availability information response message at 508. The dataset availability information response message may indicate which parameters, of the list of parameters in the request message, the UE 104 is capable of collecting continuously.

The base station 108 may, upon receiving the dataset availability information response message, determine whether to proceed with the configuration of the UE 104 for AI model training/reporting. For example, if the UE 104 is not capable of continuously collecting parameters deemed significant for the AI model training/reporting, the base station 108 may determine not to configure the UE 104 for AI model training/reporting. The baseline parameters that the UE 104 must be capable of continuously collecting in order to be configured for AI model training/reporting may be specific to the objectives of a particular embodiment and, in some instances, be based on implementation of the base station 108.

In the event the base station 108 determines the UE 104 is capable of continuously updating a sufficient portion of the dataset, it may proceed to configure the UE 104 by sending configuration information to the UE 104 at 512. The configuration information may configure the UE 104 to train and report one or more AI models similar to that described above with respect to FIG. 2. The configuration information may be based on the UE capability provided in the dataset availability information request message.

The UE 104 may perform a dataset update and model refinement and, at 516, provide an AI model report to the base station 108. In the event the UE 104 is not able to perform a dataset update (based on a periodic or trigger event), the UE 104 may include a dataset update failure indication in the AI model report. The failure indication may inform the base station 108 that the UE 104 was not able to update the dataset or, for example, the reported AI model report is not based on an updated dataset.

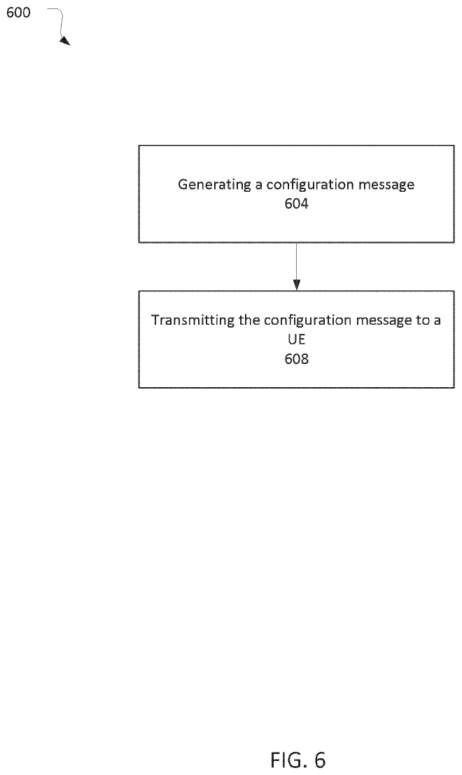

FIG. 6 provides an operation flow/algorithmic structure 600 in accordance with some embodiments. The operation flow/algorithmic structure 600 may be performed by a base station such as base station 108, base station 900; or components thereof, for example, processors 904.

The operation flow/algorithmic structure 600 may include, at 604, generating a configuration message. The configuration message may include configuration information to configure a UE to perform modeling tasks associated with AI model training or reporting similar to that discussed elsewhere herein. These modeling tasks may include, for example, dataset update, model refinement, or model reporting.

The configuration information may include one or more of: use-case information to indicate a client to which an AI model is to be reported; a container to be used to report an AI model; a dataset identification to identify a dataset to be used to obtain an AI model; a dataset update periodicity to indicate a period in which the UE is to update a dataset to be used to obtain an AI model; a model refinement periodicity to indicate a period in which the UE is to refine an AI model; a model reporting periodicity to indicate a period in which the UE is to report an AI model; a model refinement policy to indicate how the UE is to refine an AI model; a dataset volume threshold to indicate a minimum size of a dataset upon which an AI model may be obtained; or a dataset validity timer to indicate a time period in which a dataset remains valid for obtaining an AI model.

In some embodiments, the configuration message may have a configuration ID that is associated with a particular configuration that includes information relevant to both model training and model reporting. In other embodiments, the base station may generate one or more configuration messages to include a model-training configuration ID associated with a model-training configuration (for example, information to configure the UE for AI model training) and reporting configuration ID associated with a reporting configuration (for example, information to configure the UE for reporting an AI model). These may be reported in the same or different configuration messages.

In some embodiments, the information included in the configuration message may be based on UE capability information. For example, the base station may transmit a dataset availability information request to the UE. In response, the UE may provide a dataset availability information response. The response may provide an indication of a dataset update capability of the UE. The base station may configure the UE based on this capability.

The operation flow/algorithmic structure 600 may further include, at 608, transmitting the configuration message to the UE. The configuration message may be sent to an individual UE in a unicast message or to a plurality of UEs in a multicast or broadcast message. In some embodiments, the configuration message may be an RRC message.

In some embodiments, the base station may further provide an instruction to release the AI model training configuration associated with the configuration ID transmitted in the configuration message. This instruction may be included in a release message transmitted to the UE. The determination to release the AI model training configuration may be upon the initiative of the base station or may be based on a specific release request received from the UE.

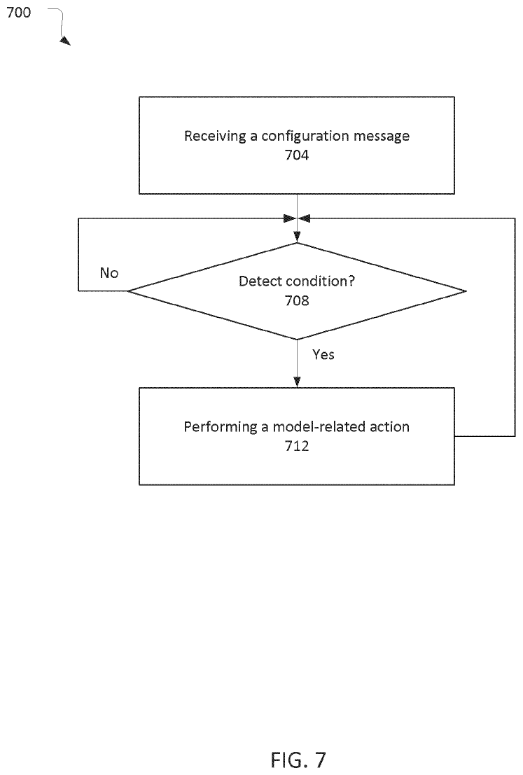

FIG. 7 provides an operation flow/algorithmic structure 700 in accordance with some embodiments. The operation flow/algorithmic structure 700 may be performed by a UE such as UE 104, UE 800; or components thereof, for example, processors 804.

The operation flow/algorithmic structure 700 may include, at 704, receiving a configuration message. The configuration message may include configuration information to configure the UE to perform modeling tasks associated with AI model training or reporting. The configuration information may be similar to that described above with respect to FIG. 6 or elsewhere herein.

The operation flow/algorithmic structure 700 may further include, at 708, attempting to detect a condition. In some embodiments, the condition may be an expiration of a timer associated with a model reporting periodicity. In these embodiments, the model report may be considered a periodic report. In other embodiments, the condition may be an event detectable by the UE. The event may be associated with: a difference between the AI model and a previous AI model being greater than a predetermined threshold; a difference between the dataset and a previous data set being greater than a predetermined threshold; a volume of the dataset being greater than a predetermined threshold; a location of the UE; a mobility of the UE; a battery level of the UE; a channel quality or status of a radio link; compute, storage, or memory resources available at the UE; reception of an indication from an application layer, network, or other UE; a change in an RRC state of the UE; or a presence of a task associated with a first priority level that is higher than second priority level associated with a model-related action. In some embodiments, some or all of the aspects of the condition may be provided in the configuration message. For example, the base station may provide an indication of the condition and any relevant thresholds.

If the condition is not detected at 708, the operation flow/algorithmic structure 700 may continue to monitor for the detected condition at 708.

If the condition is detected at 708, the operation flow/algorithmic structure 700 may advance to performing the model-related action at 712. The model-related action may be associated with a modeling task such as, for example, a dataset update, an AI model refinement, or an AI model report. The UE may perform the model-related action based on the configuration message and the detected condition.

In some embodiments, the model-related action may include performing a dataset update, model refinement, or model report. If the action includes transmission of the AI model in a model report, the UE may do so as a regular report (for example, the report includes a full AI model) or a differential report (for example, the report only includes parameters of the AI model that are different from a reference AI model).

In some embodiments, the UE may transmit a notification related to performing the model-related action to the base station.

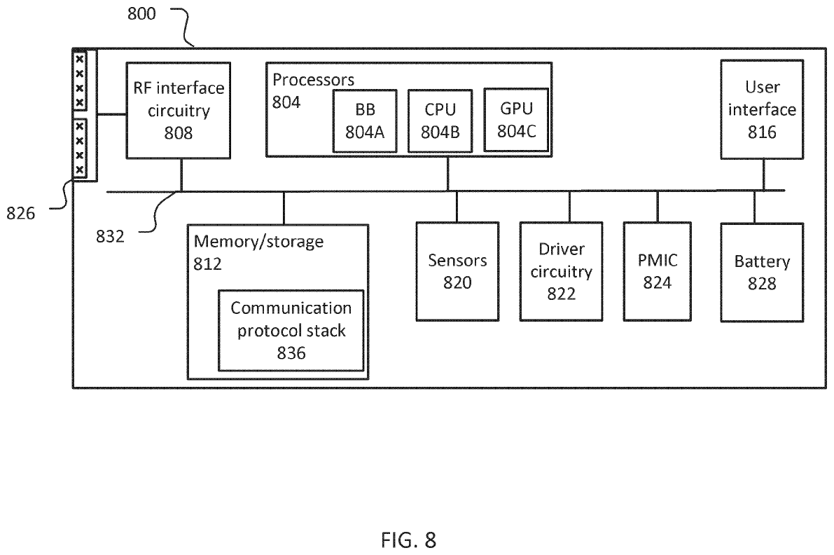

FIG. 8 illustrates an example UE 800 in accordance with some embodiments.

The UE 800 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform various operations described herein. The memory/storage 812 include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple-input, multiple-output communications. The antenna 826 may include microstrip antennas, printed antennas fabricated on the surface of one or more printed circuit boards, patch antennas, phased array antennas, etc. The antenna 826 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations such as channel quality feedback, handover, etc. The UE 800 goes into a very low power state and it performs paging where again it periodically wakes up to listen to the network and then powers down again. The UE 800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted or deployed in a fixed location, and may have a power supply coupled to an electrical grid. The battery 828 may be a lithium-ion battery or a metal-air battery such as a zinc-air battery, an aluminum-air battery, a lithium-air battery, and the like. In some implementations, such as in vehicle-based applications, the battery 828 may be a typical lead-acid automotive battery.

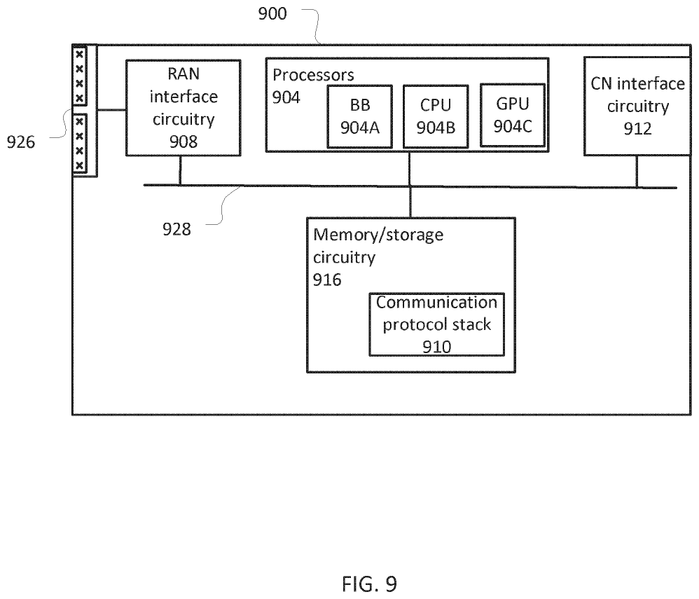

FIG. 9 illustrates an example base station 900 in accordance with some embodiments. The base station 900 may be a base station or an AMF as describe elsewhere herein. The base station 900 may include processors 904, RF interface circuitry 908, core network (CN) interface circuitry 912, memory/storage circuitry 916, and antenna structure 926. The RF interface circuitry 908 and antenna structure 926 may not be included when the base station 900 is an AMF.

The components of the base station 900 may be coupled with various other components over one or more interconnects 928.

The processors 904, RF interface circuitry 908, memory/storage circuitry 916 (including communication protocol stack 910), antenna structure 926, and interconnects 928 may be similar to like-named elements shown and described with respect to FIG. 8.

The CN interface circuitry 912 may provide connectivity to a core network, for example, a 5th Generation Core network (5GC) using a 5GC-compatible network interface protocol such as carrier Ethernet protocols, or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a base station, the method comprising: generating a configuration message having a configuration identifier (ID) and information to configure a user equipment (UE) for artificial intelligence (AI) model training or reporting; and transmitting the configuration message to the UE.

Example 2 includes the method of example 1 or some other example herein, wherein the information comprises: use-case information to indicate a client to which an AI model is to be reported; a container to be used to report an AI model; a dataset identification to identify a dataset to be used to obtain an AI model; a dataset update periodicity to indicate a period in which the UE is to update a dataset to be used to obtain an AI model; a model refinement periodicity to indicate a period in which the UE is to refine an AI model; a model reporting periodicity to indicate a period in which the UE is to report an AI model; a model refinement policy to indicate how the UE is to refine an AI model; a dataset volume threshold to indicate a minimum size of a dataset upon which an AI model may be obtained; or a dataset validity timer to indicate a time period in which a dataset remains valid for obtaining an AI model.

Example 3 includes the method of example 1 or some other example herein, further comprising: generating one or more configuration messages, including the configuration message, the one or more configuration messages to include: a model-training configuration ID and first information to configure the UE for AI model training; and a reporting configuration ID and second information to configure the UE for reporting an AI model, wherein the configuration ID is the model-training configuration ID and the information is the first information; or the configuration ID is the reporting configuration ID and the information is the second information.

Example 4 includes the method of example 1 or some other example herein, further comprising: receiving, in a radio resource control (RRC) message, one or more AI models from the UE.

Example 5 includes the method of example 1, further comprising: transmitting, to the UE, a dataset availability information request; receiving a dataset availability information response that provides an indication of a dataset update capability of the UE; and generating the configuration message based on the dataset update capability of the UE.

Example 6 includes the method of example 1 or some other example herein, wherein the configuration ID is associated with an AI model training configuration and the method further comprises: transmitting, to the UE, an instruction to release the AI model training configuration.

Example 7 includes a method of example 1 or some other example herein, wherein the configuration ID is associated with an AI model training configuration and the method further comprises: receiving, from the UE, a request to release the AI model training configuration.

Example 8 includes a method comprising: receiving a configuration message that is to configure artificial intelligence (AI) model training or reporting; detecting a condition; and performing an action based on the configuration message and the condition, wherein the action is associated with a dataset update, an AI model refinement, or an AI model report.

Example 9 includes the method of example 8 or some other example herein, wherein the action is an AI model report and the condition is an expiration of a timer associated with a model reporting periodicity.

Example 10 includes a method of example 8 or some other example herein, wherein the condition is an event associated with: a difference between an AI model and a previous AI model being greater than a predetermined threshold; a difference between a dataset and a previous dataset being greater than a predetermined threshold; a volume of a dataset being greater than a predetermined threshold; a location of the UE; a mobility of the UE; a battery level of the UE; a channel quality or status of a radio link; compute, storage, or memory resources available at the UE; reception of an indication from an application layer, network, or other UE; a change in a radio resource control (RRC) state of the UE; or a presence of a task associated with a first priority level that is higher than second priority level associated with the action.

Example 11 includes the method of example 8 or some other example herein, further comprising: transmitting, to the base station, an indication associated with performance of the action by the UE.

Example 12 includes the method of example 8 or some other example herein, wherein the action comprises: generation of an AI model; and transmission of a report to the base station to provide an indication of the AI model.

Example 13 includes the method of example 12 or some other example herein, wherein the AI model is a first AI model having a first plurality of parameters and the method further comprises: generating the report to indicate a difference between the first plurality of parameters of the first AI model and a second plurality of parameters of a second AI model that was reported to the base station prior to generation of the first AI model.

Example 14 includes the method of example 8 or some other example herein, further comprising: generating a first AI model; reporting the first AI model as a regular report; deriving at least one difference between the first AI model and a second AI model; and reporting the at least one difference as a differential report associated with the second AI model.

Example 15 includes the method of example 8 or some other example herein, wherein the action is a periodic action that includes one or more tasks and the method further comprises: receiving a command from the base station; and pausing at least one task of the one or more tasks based on the command.

Example 16 includes the method of example 15 or some other example herein, wherein the at least one task comprises: a dataset update, an AI model refinement, or an AI model report.

Example 17 includes the method of example 15 or some other example herein, wherein the command is a first command and the method further comprises: receiving a second command from the base station; and resuming the at least one task based on the second command.

Example 18 includes the method of example 15 or some other example herein, further comprising: transmitting, to the base station in UE assistance information (UAI), a request to pause the at least one task; and receiving the command based on the request.

Example 19 includes the method of example 18 or some other example herein, wherein the UAI further includes a reason for the request to pause the at least one task.

Example 20 includes a method of example 8 or some other example herein, further comprising: receiving, from the base station, a release message that includes the configuration ID; and releasing an AI model configuration associated with the configuration ID based on the release message.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
generating a configuration message having a configuration identifier (ID) and information to configure a user equipment (UE) for artificial intelligence (AI) model training or reporting; and
outputting the configuration message for transmission to the UE.

22. The method of claim 21, wherein the information comprises:
use-case information to indicate a client to which an AI model is to be reported;
a container to be used to report an AI model;
a dataset identification to identify a dataset to be used to obtain an AI model;
a dataset update periodicity to indicate a period in which the UE is to update a dataset to be used to obtain an AI model;
a model refinement periodicity to indicate a period in which the UE is to refine an AI model;
a model reporting periodicity to indicate a period in which the UE is to report an AI model;
a model refinement policy to indicate how the UE is to refine an AI model;
a dataset volume threshold to indicate a minimum size of a dataset upon which an AI model may be obtained; or
a dataset validity timer to indicate a time period in which a dataset remains valid for obtaining an AI model.

23. The method of claim 21, further comprising:
generating one or more configuration messages, including the configuration message, the one or more configuration messages to include:
a model-training configuration ID and first information to configure the UE for AI model training; and
a reporting configuration ID and second information to configure the UE for reporting an AI model,
wherein the configuration ID is the model-training configuration ID and the information is the first information; or the configuration ID is the reporting configuration ID and the information is the second information.

24. The method of claim 21, further comprising:
receiving, in a radio resource control (RRC) message, one or more AI models from the UE.

25. The method of claim 21, further comprising:
generating, for transmission to the UE, a dataset availability information request;
receiving a dataset availability information response that provides an indication of a dataset update capability of the UE; and
generating the configuration message based on the dataset update capability of the UE.

26. The method of claim 21, wherein the configuration ID is associated with an AI model training configuration and the method further comprises:
generating, for transmission to the UE, an instruction to release the AI model training configuration.

27. The method of claim 21, wherein the configuration ID is associated with an AI model training configuration and the method further comprises:
receiving, from the UE, a request to release the AI model training configuration.

28. One or more non-transitory, computer-readable media having instructions that, when executed, cause processor circuitry to:
receive a configuration message that is to configure artificial intelligence (AI) model training or reporting;
detect a condition; and
perform an action based on the configuration message and the condition, wherein the action is associated with a dataset update, an AI model refinement, or an AI model report.

29. The one or more non-transitory, computer-readable media of claim 28, wherein the action is an AI model report and the condition is an expiration of a timer associated with a model reporting periodicity.

30. The one or more non-transitory, computer-readable media of claim 28, wherein the condition is an event associated with:
a difference between an AI model and a previous AI model being greater than a predetermined threshold;
a difference between a dataset and a previous dataset being greater than a predetermined threshold;
a volume of a dataset being greater than a predetermined threshold; a location of a user equipment (UE);
a mobility of a UE;
a battery level of a UE;
a channel quality or status of a radio link;
compute, storage, or memory resources available at a UE;
reception of an indication from an application layer, network, or other UE; a change in a radio resource control (RRC) state of a UE; or
a presence of a task associated with a first priority level that is higher than second priority level associated with the action.

31. The one or more non-transitory, computer-readable media of claim 28, wherein the instructions, when executed, further cause the processor circuitry to:
transmit, to a base station, an indication associated with performance of the action by a user equipment (UE).

32. The one or more non-transitory, computer-readable media of claim 28, wherein the action comprises:
generation of an AI model; and
transmission of a report to a base station to provide an indication of the AI model.

33. The one or more non-transitory, computer-readable media of claim 32, wherein the AI model is a first AI model having a first plurality of parameters and the instructions, when executed, further cause the processor circuitry to:
generate the report to indicate a difference between the first plurality of parameters of the first AI model and a second plurality of parameters of a second AI model that was reported to the base station prior to generation of the first AI model.

34. The one or more non-transitory, computer-readable media of claim 28, wherein the instructions, when executed, further cause the processor circuitry to:
generate a first AI model;
report the first AI model as a regular report;
derive at least one difference between the first AI model and a second AI model; and
report the at least one difference as a differential report associated with the second AI model.

35. The one or more non-transitory, computer-readable media of claim 28, wherein the action is a periodic action that includes one or more tasks and the instructions, when executed, further cause the processor circuitry to:
receive a command from a base station; and
pause at least one task of the one or more tasks based on the command.

36. The one or more non-transitory, computer-readable media of claim 35, wherein the at least one task comprises: a dataset update, an AI model refinement, or an AI model report.

37. The one or more non-transitory, computer-readable media of claim 35, wherein the command is a first command and the instructions, when executed, further cause the processor circuitry to:
receive a second command from the base station; and
resume the at least one task based on the second command.

38. The one or more non-transitory, computer-readable media of claim 35, wherein the instructions, when executed, further cause the processor circuitry to:
transmit, to the base station in UE assistance information (UAI), a request to pause the at least one task; and
receive the command based on the request.

39. The one or more non-transitory, computer-readable media of claim 38, wherein the UAI further includes a reason for the request to pause the at least one task.

40. The one or more non-transitory, computer-readable media of claim 28, wherein the instructions, when executed, further cause the processor circuitry to:
receive, from a base station, a release message that includes a configuration identifier (ID); and
release an AI model configuration associated with the configuration ID based on the release message.
